(19) United States
(12) Patent Application Publication
(10) Pub. No.: US 2016/0357623 A1
(43) Pub. Date: Dec. 8, 2016

(54) ABNORMALITY DETECTION METHOD AND INFORMATION PROCESSING APPARATUS

(71) Applicant: FUJITSU LIMITED, Kawasaki-shi (JP)

(72) Inventors: Kazuaki Oishi, Nakano (JP); Yuuichi NAMAI, Oyama (JP); Yukihiko HODOHARA, Matsudo (JP); Susumu Taneoka, Kawasaki (JP); Katsuya KITAMORI, Kawasaki (JP); Kazuhiko Kobayashi, Kawasaki (JP); Naohiro WAKABAYASHI, Kawasaki (JP)

(73) Assignee: FUJITSU LIMITED, Kawasaki-shi (JP)

(21) Appl. No.: 15/149,366

(22) Filed: May 9, 2016

(30) Foreign Application Priority Data
Jun. 4, 2015 (JP) 2015-113658

(51) Int. Cl. G06F 11/07

(52) U.S. Cl. CPC G06F 11/0757; G06F 11/079

(57) ABSTRACT

A processor activates a first monitoring process for initializing a timer and a second monitoring process with higher priority than the first monitoring process. The processor executes the second monitoring process to monitor whether the first monitoring process has been executed. When determining that the first monitoring process has not been executed, the processor executing the second monitoring process determines whether the load state of the processor satisfies prescribed conditions. If the load state satisfies the prescribed conditions, the processor executing the second monitoring process initializes the timer.

### CROSS-REFERENCE TO RELATED APPLICATION

This application is based upon and claims the benefit of priority of the prior Japanese Patent Application No. 2015-113658, filed on Jun. 4, 2015, the entire contents of which are incorporated herein by reference.

### FIELD

The embodiments discussed herein relate to an abnormality detection method and an information processing apparatus.

### BACKGROUND

A processor in a computer executes programs stored in a memory. If a program has an error, the processor may enter an infinite loop or may suffer from another trouble. Then, the processor may become unable to complete the program and may go into an abnormal operating state. In the abnormal operating state, the processor uses much of its computing power for the error program, which makes it difficult for the processor itself to detect the abnormality and return to the normal state.

To deal with this, the computer may be provided with a hardware device called a watchdog timer. The watchdog timer is designed to count up or down as time passes, and when the count value reaches a predetermined value (the watchdog timer expires), send a reset signal to the processor. While the processor is in a normal state, the processor periodically returns the count value to an initial value so that the watchdog timer does not expire. If the processor goes into an abnormal operating state, the processor becomes unable to return the count value to an initial value, and thus the watchdog timer expires. When this happens, the processor is reset in response to a reset signal issued from the watchdog timer.

In connection with such a watchdog timer, in order to easily identify the cause of a processor being reset, there has been proposed an emergency operation control method for saving the internal state of the processor prior to the reset. In the proposed emergency operation control method, when a watchdog timer issues a reset signal, the internal state of the processor is saved in a memory. Then, when the saving of the internal state is completed or when a predetermined time has passed from the issuance of the reset signal, the processor is restarted.

Further, there has been proposed a restart control method for detecting a low-level program being out of control in a program hierarchy, using both a high-level monitoring program and a low-level monitoring program. In the proposed restart control method, a processor uses the high-level monitoring program to periodically initialize a watchdog timer. In addition, the processor uses the low-level monitoring program to periodically output a signal, independently of the initialization of the watchdog timer. It is counted how many times the processor has outputted the signal, and if the count value does not change while the watchdog timer is initialized a plural number of times, it is determined that the low-level program is out of control, and then the processor is restarted.

Still further, there has been proposed an abnormality detection apparatus that reduces the risk of erroneously detecting a program as being out of control even if an interrupt to a base routine occurs frequently. In the proposed abnormality detection apparatus, a processor periodically executes a periodic interrupt routine to initialize a watchdog timer, with the highest priority. The periodic interrupt routine is to count the number of times the routine has started, and when the count value exceeds a predetermined value, not to initialize the watchdog timer. The base routine is to return the count value of the periodic interrupt routine to an initial value each time prescribed processes come full circle. This prevents a program from being erroneously detected as being out of control even if the processes for the base routine are delayed.

In the techniques taught in Japanese Laid-open Patent Publication Nos. 63-316145 and 6-195244, if a process with low priority is not executed a predetermined number of times in a row although the process needs to be executed periodically, the initialization of a watchdog timer is stopped and therefore the processor is reset. However, in these techniques taught in Japanese Laid-open Patent Publication Nos. 63-316145 and 6-195244, an allowable time period from when the process with low priority fails to execute to when the initialization of the watchdog timer is stopped is fixed, and it is difficult to adjust the allowable time period. A short allowable time period increases the risk of erroneously detecting a normal high load state as an abnormal operating state. A long allowable time period increases the delay from when a processor goes into an abnormal operating state to when the processor is reset.

In addition, in the technique taught in Japanese Laid-open Patent Publication No. 58-181160, a processor is not reset immediately when a reset signal is issued by a watchdog timer. Instead, the time for the processor to save log information is kept. However, this technique needs a special hardware device for storing the log information.

### SUMMARY

According to one aspect, there is provided an abnormality detection method to be executed by a computer including a processor and a timer configured to reset the processor when the timer expires. The method includes: activating, by the processor, a first monitoring process for initializing the timer and a second monitoring process with higher priority than the first monitoring process; monitoring, by the processor executing the second monitoring process, whether the first monitoring process has been executed; determining, upon determining that the first monitoring process has not been executed, by the processor executing the second monitoring process, whether a load state of the processor satisfies prescribed conditions; and initializing the timer upon determining that the load state satisfies the prescribed conditions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing apparatus according to a first embodiment;

FIG. 2 illustrates an example of an information processing apparatus according to a second embodiment;

FIG. 3 is a block diagram illustrating an exemplary hardware configuration of a transmission apparatus;

FIG. 4 is a block diagram illustrating exemplary functions of a transmission apparatus according to a third embodiment;

FIG. 5 illustrates an example of process priorities according to the third embodiment;

FIG. 6 illustrates an example of a CPU utilization table;

FIG. 7 is a flowchart illustrating a procedure for lowest priority monitoring according to the third embodiment;

FIG. 8 is a flowchart illustrating a procedure for highest priority monitoring according to the third embodiment;

FIG. 9 is a block diagram illustrating exemplary functions of a transmission apparatus according to a fourth embodiment;

FIG. 10 illustrates an example of process priorities according to the fourth embodiment;

FIG. 11 illustrates an example of a flag list;

FIG. 12 is a flowchart illustrating an exemplary procedure for lowest priority monitoring according to the fourth embodiment;

FIG. 13 is a flowchart illustrating an exemplary procedure for intermediate priority monitoring according to the fourth embodiment; and

FIG. 14 is a flowchart illustrating an exemplary procedure for highest priority monitoring according to the fourth embodiment.

### DESCRIPTION OF EMBODIMENTS

Several embodiments will be described below with reference to the accompanying drawings, wherein like reference numerals refer to like elements throughout.

### First Embodiment

A first embodiment will be described.

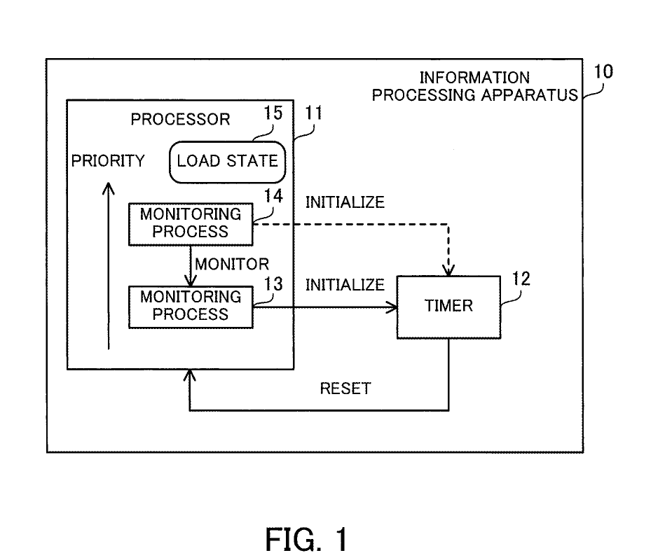

FIG. 1 illustrates an example of an information processing apparatus according to the first embodiment.

An information processing apparatus 10 of the first embodiment includes a processor 11 and a timer 12.

The processor 11 is a computing device, such as a Central Processing Unit (CPU) or a CPU core. The processor 11 loads a program to a memory and then runs the program. The processor 11 is able to execute a plurality of processes activated by one or more programs, in a time division manner according to their priorities. The processor 11 preferentially allocates a processing time (processor resources) to a process with higher priority.

The timer 12 counts up or down as time passes, and when the count value reaches a predetermined value (the timer expires), resets the processor 11. In this connection, the timer 12 is initialized by the processor 11, thereby returning the count value to an initial value. The timer 12 may be called a watchdog timer. For example, the timer 12 counts down from the initial value, which is set by the processor 11, and when the count value reaches zero, sends a reset signal to the processor 11. For example, the reset signal is sent as an interrupt signal to the processor 11.

When receiving the reset signal, the processor 11 clears the internal state, such as register values, and then restarts. For example, the processor 11 reloads a predetermined initial program to the memory, and re-executes the initial program from the beginning. This forcibly terminates and removes all processes that have been executed prior to the reset.

To this end, the processor 11 activates a monitoring process 13 (first monitoring process) and a monitoring process 14 (second monitoring process). An abnormality detection program defining the monitoring processes 13 and 14 is invoked by an initial program that is executed after the processor 11 starts. The monitoring process 13 is executed with low priority (for example, the monitoring process 13 has the lowest priority among processes that are executable by the processor 11). The monitoring process 14 is executed with higher priority than the monitoring process 13 (for example, the monitoring process 14 has the highest priority among processes that are executable by the processor 11). The priorities of a plurality of processes including the monitoring processes 13 and 14 are managed by, for example, an Operating System (OS).

The monitoring process 13 initializes the timer continually (for example, intermittently at predetermined intervals). For example, the monitoring process 13 rewrites the register value of the timer 12 to an initial value. Assume that the intervals for executing the monitoring process 13 are shorter than a period of time taken from when the timer 12 is initialized to when the timer 12 expires. While the monitoring process 13 is executed normally, the timer 12 is initialized before the timer 12 expires. This prevents the processor 11 from being reset by the timer 12.

In the case where a process with higher priority than the monitoring process 13 causes a high load, there may not be sufficient processor resources for allocation to the monitoring process 13, so that the monitoring process 13 may fail to execute at a scheduled time. This, in turn, prevents the timer 12 from being initialized at a scheduled time. A process causes a high load for the following states: one is that the process is executed normally but the load thereof is high temporarily (normal high load state); and the other is that the process enters an infinite loop due to a program error and thus fails to exit the loop (abnormal operating state).

In the abnormal operating state, it is preferable that the processor 11 be reset by the timer 12 immediately. However, in the normal high load state, it is preferable that the processor 11 not be reset. To deal with this, the monitoring process 14 operates as follows.

The monitoring process 14 monitors whether the monitoring process 13 was executed at a scheduled time. For example, the monitoring process 14 confirms the count value of the timer 12, and if a change in the count value from the previous count value is greater than a threshold, determines that the monitoring process 13 has not been executed. Alternatively, for example, the monitoring process 13 may be designed to write a flag in a memory or register for every execution of the monitoring process 13. Then, in the case where no flag is written in the memory or register, the monitoring process 14 determines that the monitoring process 13 has not been executed. It is preferable that the intervals for executing the monitoring process 14 be equal to or slightly longer than those for executing the monitoring process 13.

When determining that the monitoring process 13 has not been executed, the monitoring process 14 confirms the load state 15 of the processor 11 to determine whether the load state 15 satisfies prescribed conditions. The load state 15 includes the processor utilization of each process executed by the processor 11, for example. The determination of whether the load state 15 satisfies the prescribed conditions involves a comparison between the load state 15 and a history of past processor utilization of each process. The monitoring process 14 may collect the history of past processor utilization of each process.

The prescribed conditions include a condition where processes currently executed by the processor 11 do not include a process whose current processor utilization exceeds the maximum value of past processor utilization. The prescribed conditions also include a condition where, among the processes currently executed by the processor 11, the number of processes whose current processor utilization is greater than the average value of past processor utilization is less than or equal to a threshold, for example. In the case where the load state 15 satisfies the prescribed conditions, the monitoring process 14 presumes that the processor 11 is in the normal high load state, and then initializes the timer 12, in place of the monitoring process 13. In the case where the load state 15 does not satisfy the prescribed conditions, on the other hand, the monitoring process 14 presumes that the processor 11 is in the abnormal operating state, and therefore does not initialize the timer 12.

As described above, in the information processing apparatus 10 of the first embodiment, the monitoring process 13 that initializes the timer 12 and the monitoring process 14 that has higher priority than the monitoring process 13 are activated. The monitoring process 14 monitors whether the monitoring process 13 has been executed. If the monitoring process 13 has not been executed, then the monitoring process 14 determines whether the load state 15 of the processor 11 satisfies the prescribed conditions. If the load state 15 satisfies the prescribed conditions, the monitoring process 14 initializes the timer 14, in place of the monitoring process 13.

Therefore, even when the monitoring process 13 has not been executed, the timer 12 is initialized if the processor 11 is determined to be in the normal high load state, which prevents the processor 11 from being reset. If the processor 11 is determined to be in the abnormal operating state, the timer 12 is not initialized and thus the processor 11 is reset. Compared with a method where an allowable time period from when the monitoring process 13 fails to execute to when the initialization of the timer 12 is stopped is fixed, it is possible to reduce the risk of resetting the processor 11 in the normal operating state. In addition, compared with the method employing such a fixed allowable time period, it is possible to reduce the delay from when the processor 11 goes into the abnormal operating state to when the processor 11 is reset. As a result, it becomes possible to adjust the time when the timer 12 expires.

### Second Embodiment

A second embodiment will now be described.

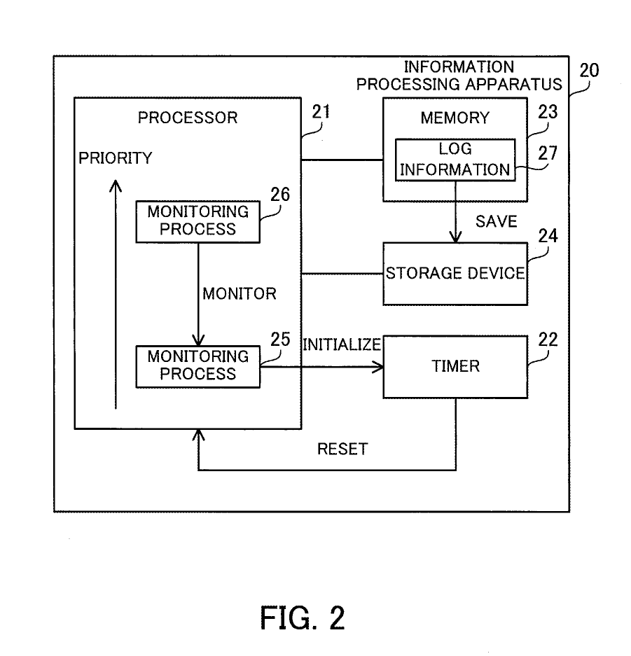

FIG. 2 illustrates an example of an information processing apparatus according to the second embodiment.

An information processing apparatus 20 of the second embodiment includes a processor 21, a timer 22, a memory 23, and a storage device 24. The processor 21 corresponds to the processor 11 of the first embodiment. The timer 22 corresponds to the timer 12 of the first embodiment.

The memory 23 is a volatile storage device, such as a Random Access Memory (RAM). The memory 23 temporarily stores programs that are executed by the processor 21 and data that is used by the processor 21. Log information 27 is generated on the memory 23. The log information 27 indicates the execution states of processes executed by the processor 21. For example, the log information 27 includes error messages generated by an OS, information about inter-process communication, a communication history, hardware configuration information, and others. When the processor 21 is reset, the log information 27 is deleted from the memory 23. The storage device 24 is a non-volatile storage device, such as a flash memory, a Solid State Drive (SSD), or a Hard Disk Drive (HDD). In this connection, the storage device 24 may be provided external to the information processing apparatus 20.

The processor 21 activates a monitoring process (first monitoring process) and a monitoring process 26 (second monitoring process). The monitoring processes 25 and 26 correspond to the monitoring processes 13 and 14 of the first embodiment, respectively. The monitoring process 25 is executed with low priority (for example, the lowest priority). The monitoring process 26 is executed with higher priority (for example, the highest priority) than the monitoring process 25.

The monitoring process 25 initializes the timer 22 continually (for example, intermittently at predetermined intervals). The monitoring process 26 monitors whether the monitoring process 25 was executed at a scheduled time. If the monitoring process 25 was not executed, the monitoring process 26 determines that there is a possibility of resetting the processor 21.

If there is a possibility of resetting the processor 21, the monitoring process 26 saves the log information 27 from the memory 23 to the storage device 24 before the processor 21 is reset. That is, the monitoring process 26 stores the log information 27 held in the memory 23, in the storage device 24. The log information 27 may be generated by the monitoring process 26 after a non-execution of the monitoring process 25 is detected. Alternatively, the log information 27 may be generated by an OS or another before the non-execution of the monitoring process 25 is detected.

In the information processing apparatus 20 of the second embodiment, the monitoring process 25 that initializes the timer 22 and the monitoring process 26 with higher priority than the monitoring process 25 are activated. The monitoring process 26 monitors whether the monitoring process 25 has been executed. If the monitoring process 25 has not been executed, the monitoring process 26 saves the log information 27 from the memory 23 to the storage device 24 before the processor 21 is reset.

This approach allows the log information 27 to remain in the non-volatile storage device 24 even after the processor 21 is reset. Thereby, it becomes easy to identify the cause of the processor 21 being reset. In addition, the approach does not need to provide the processor 21 or the timer 22 with special hardware devices, and achieves easy saving of the log information 27.

In this connection, this second embodiment may be combined with the above-described first embodiment as follows. For example, when determining that the monitoring process 25 has not been executed, the monitoring process 26 saves the log information 27 to the storage device 24 and also confirms the load state of the processor 21. If the load state satisfies prescribed conditions, the monitoring process 26 may initialize the timer 22, in place of the monitoring process 25, as described in the first embodiment.

### Third Embodiment

A third embodiment will be described.

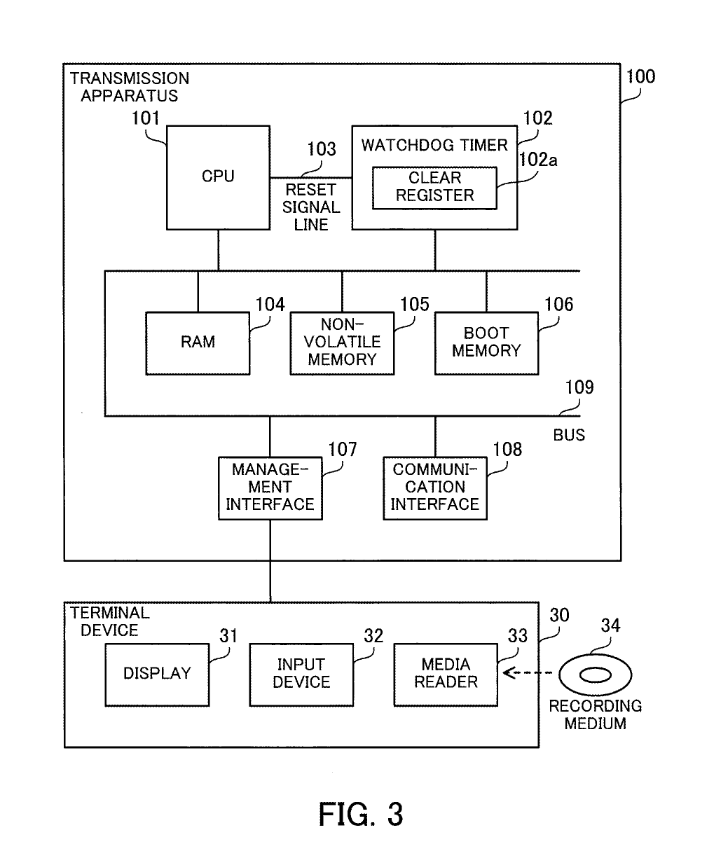

FIG. 3 is a block diagram illustrating an exemplary hardware configuration of a transmission apparatus.

A transmission apparatus 100 of the third embodiment is a communication device, such as a router or switch, to relay communication. The transmission apparatus 100 may be called an information processing apparatus or a computer, considering that it is controlled by programs. The transmission apparatus 100 corresponds to the information processing apparatus 10 of the first embodiment or the information processing apparatus 20 of the second embodiment.

The transmission apparatus 100 includes a CPU 101, a watchdog timer 102, a RAM 104, a non-volatile memory 105, a boot memory 106, a management interface 107, and a communication interface 108. The above units are connected to a bus 109. In addition, the CPU 101 and the watchdog timer 102 are connected with a reset signal line 103.

The CPU 101 corresponds to the processor 11 of the first embodiment and the processor 21 of the second embodiment. The watchdog timer 102 corresponds to the timer 12 of the first embodiment and the timer 22 of the second embodiment. The RAM 104 corresponds to the memory 23 of the second embodiment. The non-volatile memory 105 corresponds to the storage device 24 of the second embodiment.

The CPU 101 is a processor that executes program instructions. The CPU 101 loads a program from the boot memory 106 to the RAM 104 and then executes the program. The CPU 101 may execute a plurality of processes invoked by the program, in a time division manner. Each of the plurality of processes is given a priority by an OS, and is allocated a processing time (CPU resources) according to the priority. The CPU 101 may be provided with a plurality of CPU cores, and the transmission apparatus 100 may be provided with a plurality of CPUs. A set of CPUs (multiprocessor) may be called a “processor”.

The watchdog timer 102 is a timer that sends a reset signal to the CPU 101 through the reset signal line 103 when it expires. The reset signal is sent as an interrupt signal to the CPU 101. When receiving the reset signal from the watchdog timer 102, the CPU 101 clears the internal state, such as register values, and then restarts. When the CPU 101 restarts, a program is re-loaded from the boot memory 106 to the RAM 104 and then the program is executed from the beginning. That is to say, when the reset signal is issued, the processes running on the CPU 101 before the reset are forcibly terminated. In this connection, the watchdog timer 102 may send the reset signal to the CPU 101 via the bus 109, instead of using the reset signal line 103.

The watchdog timer 102 includes a clear register 102a, which is a volatile storage device. The CPU 101 writes an initial count value (positive integer) in the clear register 102a via the bus 109. The watchdog timer 102 decrements (counts down) the count value stored in the clear register 102a one by one as time passes. When the count value stored in the clear register 102a decreases to zero (the watchdog timer expires), the watchdog timer 102 sends a reset signal to the CPU 101.

The RAM 104 is a volatile semiconductor memory that temporarily stores programs that are executed by the CPU 101 and data that is used when the CPU 101 operates. When the CPU 101 is reset, the data stored in the RAM 104 is deleted. In this connection, the transmission apparatus 100 may be provided with another kind of memory than the RAM or a plurality of memories.

The non-volatile memory 105 is a non-volatile storage device that stores a variety of data including logs indicating the operating state of the transmission apparatus 100, control information to be used for controlling the transmission apparatus 100, and others. The data stored in the non-volatile memory 105 may include OS log messages, information about inter-process communication, operational information including a temperature, a fan rotation count, and a history of use of the communication interface 108, hardware configuration information, and others. As the non-volatile memory 105, a flash memory, an SSD, or another may be used. In this connection, the transmission apparatus 100 may be provided with another kind of storage device, such as an HDD, or a plurality of non-volatile storage devices.

The boot memory 106 is a non-volatile storage device that stores a variety of programs that are executed by the CPU 101. The programs stored in the boot memory 106 include a Basic Input Output System (BIOS) program, an initialization program that is invoked by the BIOS, an OS program, a control program for controlling the transmission apparatus 100, and others. The control program includes an abnormality detection program for detecting an abnormality in the CPU 101 with the watchdog timer 102. As the boot memory 106, a Read Only Memory (ROM), a flash memory, or another may be used, for example.

The management interface 107 is connected to a terminal device 30 that is operated by a user. The terminal device 30 includes a display 31, an input device 32, and a media reader 33. In this connection, the terminal device 30 may further include a CPU, a RAM, a non-volatile storage device, a communication interface, and others. In addition, the display 31 and input device 32 may be provided external to the terminal device 30. In this case, the terminal device 30 is provided with a video signal interface that allows the display 31 to be connected thereto and an input signal interface that allows the input device 32 to be connected thereto.

The display 31 displays images. As the display 31, a Cathode Ray Tube (CRT) display, a Liquid Crystal Display (LCD), a Plasma Display Panel (PDP), an Organic Electro-Luminescence (OEL) display, and another may be used.

The input device 32 receives input operations from a user. As the input device 32, a pointing device, such as a mouse, a tough panel, a touchpad, or a track ball, a keyboard, a remote controller, a button switch, or another may be used. The terminal device 30 may be provided with plural types of input devices.

The media reader 33 is a reading device for reading programs and data from a recording medium 34. As the recording medium 34, a magnetic disk, such as a flexible disk (FD) or an HDD, an optical disc, such as a Compact Disc (CD) or a Digital Versatile Disc (DVD), a Magneto-Optical disk (MO), a semiconductor memory, or another may be used. The programs or data read from the recording medium 34 may be transferred to the non-volatile memory 105 or boot memory 106.

The communication interface 108 is used for connecting with an information processing apparatus or another transmission apparatus. The communication interface 108 may be provided with a plurality of communication ports. The usage of each communication port is controlled by and the use state thereof is monitored by the CPU 101.

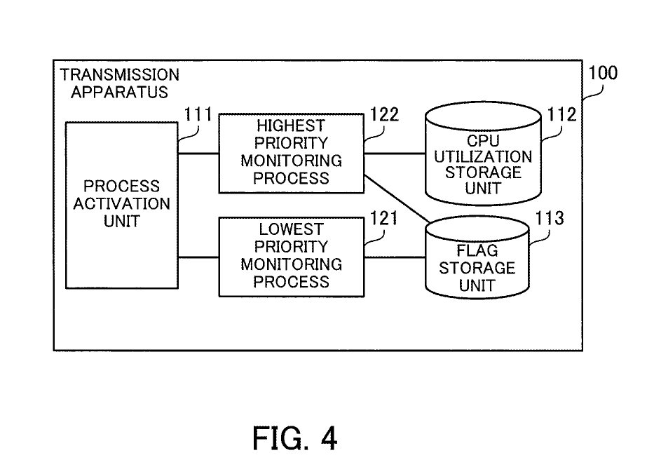

FIG. 4 is a block diagram illustrating exemplary functions of a transmission apparatus according to the third embodiment.

The transmission apparatus 100 includes a process activation unit 111, a CPU utilization storage unit 112, a flag storage unit 113, a lowest priority monitoring process 121, and a highest priority monitoring process 122. The CPU utilization storage unit 112 and flag storage unit 113 are implemented by using storage space saved in the RAM 104. The process activation unit 111, lowest priority monitoring process 121, and highest priority monitoring process 122 are implemented by programs that are executed by the CPU 101.

The process activation unit 111 is initiated by an initialization program that is invoked by a BIOS program. When the CPU 101 starts, the process activation unit 111 activates the lowest priority monitoring process 121 and the highest priority monitoring process 122 at the initial stage.

The CPU utilization storage unit 112 stores a history of CPU utilization for each process that is executed by the CPU 101. The histories of CPU utilization are collected by the highest priority monitoring process 122. The histories of CPU utilization will be described in detail later. The flag storage unit 113 stores a flag indicating whether the lowest priority monitoring process 121 has been executed. When the lowest priority monitoring process 121 is executed, the flag is updated to ON (“1”). When the flag has been confirmed by the highest priority monitoring process 122, the flag is updated to OFF (“0”). In this connection, in the case where another method is employed for confirming whether the lowest priority monitoring process 121 has been executed, the transmission apparatus 100 may be configured without the flag storage unit 113, as will be described later.

The lowest priority monitoring process 121 is executed with the lowest priority among processes that are executable by the CPU 101. The lowest priority monitoring process 121 periodically writes an initial count value in the clear register 102a of the watchdog timer 102 (that is, periodically initializes the watchdog timer 102). The intervals for executing the lowest priority monitoring process 121 are set shorter than a period of time needed for the count of the watchdog timer 102 to decrease from the initial value to zero, and for example, set to about 10 seconds.

While the lowest priority monitoring process 121 is executed normally, the watchdog timer 102 does not issue a reset signal. However, if a high load is imposed on the CPU 101, the amount of CPU resources to be allocated to the lowest priority monitoring process 121 by the OS is reduced, which may prevent the lowest priority monitoring process 121 from being executed at a scheduled time. When initializing the watchdog timer 102, the lowest priority monitoring process 121 updates the flag stored in the flag storage unit 113 to ON.

The highest priority monitoring process 122 is executed with the highest priority among processes that are executable by the CPU 101. The highest priority monitoring process 122 periodically obtains information about the current CPU utilization of each process being executed by the CPU 101, from the OS, and updates histories stored in the CPU utilization storage unit 112. In addition, the highest priority monitoring process 122 periodically confirms whether the lowest priority monitoring process 121 is executed normally, with reference to the flag stored in the flag storage unit 113. Alternatively, the highest priority monitoring process 122 periodically confirms whether the watchdog timer 102 is initialized normally, with reference to the clear register 102a. The intervals for executing the highest priority monitoring process 122 are set slightly longer than or equal to those for executing the lowest priority monitoring process 121, and for example, set to 10 to 20 seconds.

When determining that the lowest priority monitoring process 121 is not executed normally, the highest priority monitoring process 122 collects logs from the RAM 104. The logs include OS error messages, information about inter-process communication, a history of use of the communication interface 108, environmental information including a temperature and a fan rotation count, hardware configuration information, and others. The logs are useful information for identifying the cause of the CPU 101 being reset. The highest priority monitoring process 122 stores the collected logs in the non-volatile memory 105.

In addition, when determining that the lowest priority monitoring process 121 is not executed normally, the highest priority monitoring process 122 confirms the current CPU utilization of each of the plurality of processes. The highest priority monitoring process 122 compares the current CPU utilization with the corresponding history stored in the CPU utilization storage unit 112, to determine whether the CPU 101 is in a normal high load state or in an abnormal operating state.

The normal high load state is that a process is executed normally but the load thereof is temporarily high. The abnormal operating state is that a process does not end undesirably due to execution of an infinite loop caused by a program error. When presuming that the CPU 101 is in the normal high load state, the highest priority monitoring process 122 initializes the watchdog timer 102, in place of the lowest priority monitoring process 121. When presuming that the CPU 101 is in the abnormal operating state, the highest priority monitoring process 122 does not initialize the watchdog timer 102, thereby allowing a reset signal to be issued. How to determine whether the CPU 101 is in the normal high load state or in the abnormal operating state will be described in detail later.

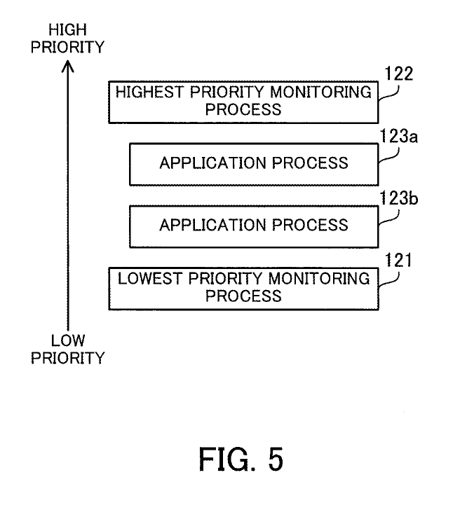

FIG. 5 illustrates an example of process priorities according to the third embodiment.

A plurality of processes that are executed in a time division manner by the CPU 101 are managed by the OS. The OS gives a priority to each of the processes, and allocates the processing time of the CPU 101 to each process according to the priority. The OS preferentially allocates the processing time of the CPU 101 to a process with higher priority than that with lower priority.

As described earlier, the lowest priority monitoring process 121 is executed with the lowest priority among the plurality of priorities that are assignable by the OS. The highest priority monitoring process 122 is executed with the highest priority among the plurality of priorities that are assignable by the OS. In primary, other processes are executed with higher priority than the lowest priority monitoring process 121 but lower priority than the highest priority monitoring process 122. For example, application processes 123a and 123b that are activated by an application program are given priorities between the highest priority and the lowest priority.

For example, assume now that the application process 123a is out of control, that is, the application process 123a does not end undesirably due to an error in the application program. In this case, the highest priority monitoring process 122 is preferentially allocated CPU resources, so that the highest priority monitoring process 122 is probably executed at a scheduled time. On the other hand, it is considered that many CPU resources are consumed by the application process 123a and therefore little CPU resources are allocated to the lowest priority monitoring process 121. Therefore, the lowest priority monitoring process 121 may probably fail to execute at a scheduled time.

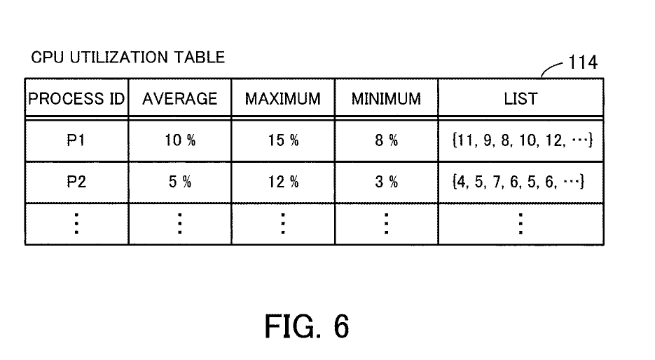

FIG. 6 illustrates an example of a CPU utilization table.

A CPU utilization table 114 is stored in the CPU utilization storage unit 112, and has the following fields: Process ID, Average, Maximum, Minimum, and List.

A Process ID field contains identification information identifying a process that is executed by the CPU 101. Processes registered in the CPU utilization table 114 may or may not include the lowest priority monitoring process 121 and the highest priority monitoring process 122.

The Average field indicates the average value of past CPU utilization of a process identified by a corresponding process ID. The Maximum field indicates the maximum value of past CPU utilization of a process identified by a corresponding process ID. The Minimum field indicates the minimum value of past CPU utilization of a process identified by a corresponding process ID. The List field lists CPU utilization values periodically obtained from the OS, for each process. The CPU utilization values obtained after the CPU 101 started most recently are listed. In this connection, old CPU utilization values that are listed for a predetermined period of time or longer may be removed. The above average value, maximum value, and minimum value are calculated on the basis of the list.

The following describes how the lowest priority monitoring process 121 and the highest priority monitoring process 122 operate.

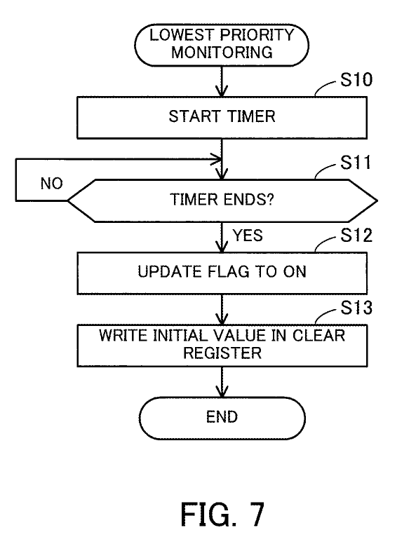

FIG. 7 is a flowchart illustrating a procedure for lowest priority monitoring according to the third embodiment.

The lowest priority monitoring process 121 repeats the procedure of FIG. 7.

(S10) The lowest priority monitoring process 121 starts a timer. The timer used here may be a software timer provided in the OS or a hardware timer other than the watchdog timer 102 provided in the transmission apparatus 100. The timer is set at a shorter time than the watchdog timer 102, and for example, set to about 10 seconds.

(S11) The lowest priority monitoring process 121 waits for the timer, which started at step S10, to end. When the timer ends, the procedure proceeds to step S12. The procedure stays at step S11 until the timer ends. In this case, the lowest priority monitoring process 121 may go into sleep until the timer ends. In this connection, this sleep state is ended by an interrupt from the OS or hardware timer.

(S12) The lowest priority monitoring process 121 updates the flag stored in the flag storage unit 113 to ON (“1”). In this connection, in the case where the highest priority monitoring process 122 does not refer to the flag, the lowest priority monitoring process 121 does not need to update the flag, as will be described later.

(S13) The lowest priority monitoring process 121 writes an initial count value in the clear register 102a of the watchdog timer 102. The initial count value is a positive integer, and is set when the transmission apparatus 100 is designed, with taking into account the maximum waiting time taken until reset. Then, the lowest priority monitoring process 121 proceeds back to step S10 to repeat the procedure.

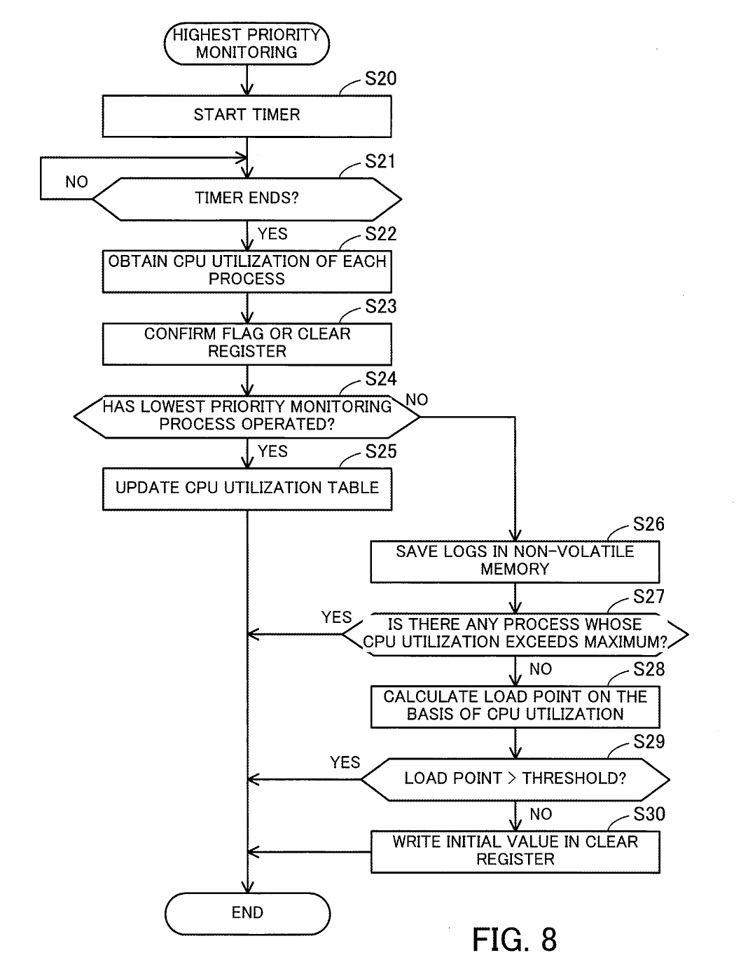

FIG. 8 is a flowchart illustrating a procedure for highest priority monitoring according to the third embodiment.

The highest priority monitoring process 122 repeats the procedure of FIG. 8.

(S20) The highest priority monitoring process 122 starts a timer. The timer used here may be a software timer provided in the OS or a hardware timer other than the watchdog timer 102 provided in the transmission apparatus 100. The timer is set equal to or slightly longer than a time for the lowest priority monitoring process 121, and for example, set to about 10 to 20 seconds.

(S21) The highest priority monitoring process 122 waits for the timer, which started at step S20, to end. When the timer ends, the procedure proceeds to step S22. The procedure stays at step S21 until the timer ends. In this case, the highest priority monitoring process 122 may go into sleep until the timer ends. In this connection, this sleep state is ended by an interrupt from the OS or hardware timer.

(S22) The highest priority monitoring process 122 obtains information indicating the current CPU utilization of each process being executed by the CPU 101, from the OS.

(S23) The highest priority monitoring process 122 confirms whether the lowest priority monitoring process 121 has operated. For example, the highest priority monitoring process 122 refers to the flag stored in the flag storage unit 113. A flag of ON (“1”) indicates that the lowest priority monitoring process 121 has operated. A flag of OFF (“0”) indicates that the lowest priority monitoring process 121 has not operated. After referring to the flag, the highest priority monitoring process 122 returns the flag to OFF.

Alternatively, for example, the highest priority monitoring process 122 refers to the count value stored in the clear register 102a of the watchdog timer 102. In the case where a difference between the current count value and the previous count value is less than or equal to a threshold, the highest priority monitoring process 122 determines that the count value has been initialized, that is, that the lowest priority monitoring process 121 has operated. In the case where the difference between the current count value and the previous count value exceeds the threshold, on the other hand, the highest priority monitoring process 122 determines that the count value has not been initialized, that is, that the lowest priority monitoring process 121 has not operated.

(S24) If it is determined at step S23 that the lowest priority monitoring process 121 has operated, the procedure proceeds to step S25. If it is determined at step S23 that the lowest priority monitoring process 121 has not operated, the procedure proceeds to step S26.

(S25) The highest priority monitoring process 122 updates the CPU utilization table 114 stored in the CPU utilization storage unit 112 on the basis of the CPU utilization obtained at step S22. More specifically, the highest priority monitoring process 122 adds the latest CPU utilization of each process to the list. In addition, the highest priority monitoring process 122 updates the average value of CPU utilization on the basis of the updated list. In addition, the highest priority monitoring process 122 updates the maximum value of CPU utilization if the latest CPU utilization exceeds the maximum value of past CPU utilization, and updates the minimum value of CPU utilization if the latest CPU utilization is less than the minimum value of past CPU utilization. Then, the highest priority monitoring process 122 proceeds back to step S20 to repeat the procedure.

(S26) The highest priority monitoring process 122 collects logs from the RAM 104. For example, the logs include OS error messages, information about inter-process communication, a history of use of the communication interface 108, environmental information including a temperature and a fan rotation count, hardware configuration information, and others. The highest priority monitoring process 122 saves the collected logs in the non-volatile memory 105.

(S27) The highest priority monitoring process 122 compares the latest CPU utilization with the maximum value registered in the CPU utilization table 114, for each process. The highest priority monitoring process 122 determines whether there is any process whose latest CPU utilization exceeds the past maximum value among the processes being executed by the CPU 101. If such a process is detected, the highest priority monitoring process 122 presumes that the CPU 101 is in the abnormal operating state. Then, the highest priority monitoring process 122 proceeds back to step S20 to repeat the procedure. If no such a process is detected, the procedure proceeds to step S28.

(S28) The highest priority monitoring process 122 calculates a load point on the basis of the latest CPU utilization and the CPU utilization table 114. The highest priority monitoring process 122 adds one to the load point per process satisfying a relative load criterion, and adds one to the load point per process satisfying an absolute load criterion.

A process satisfying the relative load state is a process whose relative CPU utilization to other processes is usually not high but is currently high. For example, the highest priority monitoring process 122 sorts processes in descending order of average CPU utilization, and calculates the ranking for the normal time. In addition, the highest priority monitoring process 122 sorts the processes in descending order of latest CPU utilization, and calculates the current ranking. A process which usually does not have a predetermined rank or higher (for example, a rank in the top ten) but currently has the predetermined rank or higher is taken as a process satisfying the relative load criterion. A process satisfying the absolute load criterion is a process whose CPU utilization is higher than the average value but is smaller than the past maximum value.

(S29) The highest priority monitoring process 122 determines whether the load point calculated at step S28 exceeds a threshold. The threshold is set when the transmission apparatus 100 is designed. If the load point exceeds the threshold, the highest priority monitoring process 122 presumes that the CPU 101 is in the abnormal operating state. Then, the highest priority monitoring process 122 proceeds to step S20 to repeat the procedure. If the load point is less than or equal to the threshold, the highest priority monitoring process 122 presumes that the CPU 101 is in the normal high load state. Then, the process proceeds to step S30.

(S30) The highest priority monitoring process 122 writes the initial count value in the clear register 102a of the watchdog timer 102, in place of the lowest priority monitoring process 121. Then, the highest priority monitoring process 122 proceeds back to step S20 to repeat the procedure.

With the transmission apparatus 100 of the third embodiment, the highest priority monitoring process 122 monitors whether the lowest priority monitoring process 121 that initializes the watchdog timer 102 is operating. When determining that the lowest priority monitoring process 121 is not operating, the highest priority monitoring process 122 saves logs from the RAM 104 to the non-volatile memory 105. In addition, the highest priority monitoring process 122 collects the CPU utilization of each process. In the case where the CPU utilization is not significantly high compared with the past CPU utilization, the highest priority monitoring process 122 initializes the watchdog timer 102, in place of the lowest priority monitoring process 121.

Therefore, in the case where it is presumed that the CPU 101 is in the normal high load state, the watchdog timer 102 is initialized, which minimizes the risk of erroneously resetting the CPU 101. In the case where it is presumed that the CPU 101 is in the abnormal operating state, on the other hand, the watchdog timer 102 is not initialized, but the CPU 101 is reset promptly. As a result, it is possible to appropriately adjust the time at which the watchdog timer 102 sends a reset signal, according to the load state of the CPU 101 obtained when the lowest priority monitoring process 121 fails to operate. In addition, logs are saved before the CPU 101 is reset, which makes it easy to identify the cause of a reset.

### Fourth Embodiment

The following describes a fourth embodiment.

Differential features from the third embodiment will mainly be described, and the same features as the third embodiment will not be described. A transmission apparatus 200 of the fourth embodiment is implemented with the same hardware configuration as the transmission apparatus 100 of the third embodiment illustrated in FIG. 3.

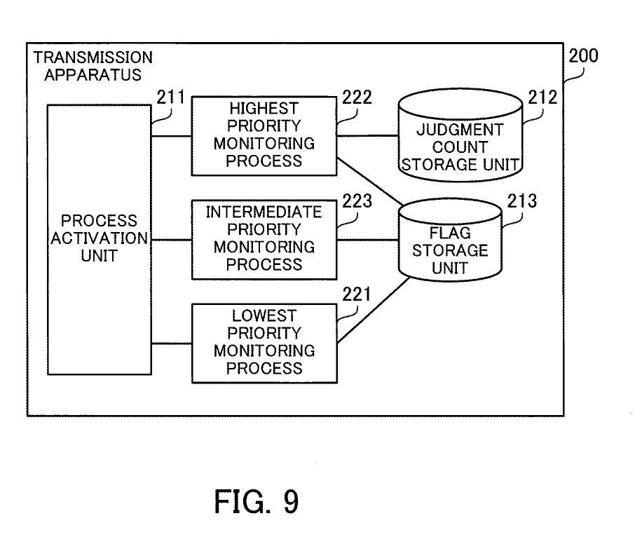

FIG. 9 is a block diagram illustrating exemplary functions of a transmission apparatus according to the fourth embodiment.

The transmission apparatus 200 includes a process activation unit 211, a judgment count storage unit 212, a flag storage unit 213, a lowest priority monitoring process 221, a highest priority monitoring process 222, and an intermediate priority monitoring process 223. The judgment count storage unit 212 is implemented by using storage space saved in a RAM 104. The flag storage unit 213 is implemented by using storage space saved in a register provided in a CPU 101 or the RAM 104. The process activation unit 211, lowest priority monitoring process 221, highest priority monitoring process 222, and intermediate priority monitoring process 223 are implemented by the CPU 101 executing programs.

The process activation unit 211, lowest priority monitoring process 221, highest priority monitoring process 222 correspond to the process activation unit 111, lowest priority monitoring process 121, and highest priority monitoring process 122 of the third embodiment illustrated in FIG. 4, respectively.

When the CPU 101 starts, the process activation unit 211 activates the lowest priority monitoring process 221, highest priority monitoring process 222, and intermediate priority monitoring process 223.

The judgment count storage unit 212 stores a judgment counter. The judgment counter indicates how many times non-execution of at least one of the lowest priority monitoring process 221, highest priority monitoring process 222, and intermediate priority monitoring process 223 was detected in a row. The judgment counter is updated by the highest priority monitoring process 222.

The flag storage unit 213 stores a set of flags respectively indicating whether the lowest priority monitoring process 221, highest priority monitoring process 222, and intermediate priority monitoring process 223 have been executed or not. When the lowest priority monitoring process 221 is executed, its corresponding flag is updated to ON (“1”). When the highest priority monitoring process 222 is executed, its corresponding flag is updated to ON. When the intermediate priority monitoring process 223 is executed, its corresponding flag is updated to ON. When the flags have been confirmed by the highest priority monitoring process 222, all the flags in the flag storage unit 213 are updated to OFF (“0”). In this connection, in the case where registers in the CPU 101 are used, different flags may be stored in different registers, or different flags may be registered at different bits in the same register.

The lowest priority monitoring process 221 is executed with the lowest priority among processes that are executable by the CPU 101. The lowest priority monitoring process 221 periodically writes an initial count value in a clear register 102a of a watchdog timer 102 (that is, periodically initializes the watchdog timer 102). When initializing the watchdog timer 102, the lowest priority monitoring process 221 updates the flag corresponding to the lowest priority monitoring process 221 to ON among the flags stored in the flag storage unit 213.

The highest priority monitoring process 222 is executed with the highest priority among processes that are executable by the CPU 101. The highest priority monitoring process 222 periodically refers to the set of flags stored in the flag storage unit 213 to confirm whether all monitoring processes (lowest priority monitoring process 221, highest priority monitoring process 222, and intermediate priority monitoring process 223) are executed normally. If at least one of these monitoring processes is not executed normally, the highest priority monitoring process 222 collects logs from the RAM 104. The logs include the set of flags stored in the flag storage unit 213, in addition to those described in the third embodiment. The highest priority monitoring process 222 stores the logs in a non-volatile memory 105.

If at least one of the monitoring processes is not executed normally, the highest priority monitoring process 222 increments the judgment counter stored in the judgment count storage unit 212 by one. When the value of the judgment counter is less than or equal to a threshold (for example, six), the highest priority monitoring process 222 initializes the watchdog timer 102, in place of the lowest priority monitoring process 221. When the value of the judgment counter exceeds the threshold, the highest priority monitoring process 222 stops the initialization of the watchdog timer 102, thereby allowing a reset signal to be issued. In this connection, in the case where all of the monitoring processes are executed normally, the highest priority monitoring process 222 initializes the judgment counter stored in the judgment count storage unit 212 to zero.

The intermediate priority monitoring process 223 is executed with a predetermined priority between the highest priority and the lowest priority. This priority is set in advance. The intermediate priority monitoring process 223 periodically updates its corresponding flag to ON among the flags stored in the flag storage unit 213. The intervals for executing the intermediate priority monitoring process 223 are the same as those for executing the lowest priority monitoring process 221, and for example, set to about 10 seconds.

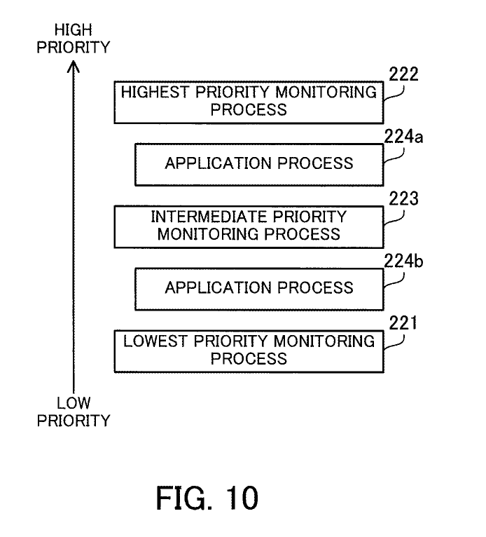

FIG. 10 illustrates an example of process priorities according to the fourth embodiment.

As described above, the lowest priority monitoring process 221 is executed with the lowest priority among a plurality of priorities that are assignable by the OS. The highest priority monitoring process 222 is executed with the highest priority among the plurality of priorities that are assignable by the OS. The intermediate priority monitoring process 223 is executed with a predetermined priority between the highest priority and the lowest priority among the plurality of priorities that are assignable by the OS.

For example, assume that an application process 224a is given a priority between the priority of the highest priority monitoring process 222 and the priority of the intermediate priority monitoring process 223. It is also assumed that an application process 224b is given a priority between the priority of the intermediate monitoring process 223 and the priority of the lowest priority monitoring process 221. In the case where the application process 224a becomes out of control, the highest priority monitoring process 222 is executed normally, but the intermediate priority monitoring process 223 and the lowest priority monitoring process 221 may probably fail to execute. On the other hand, in the case where the application process 224b becomes out of control, the highest priority monitoring process 222 and the intermediate process monitoring process 223 are executed normally, but the lowest priority monitoring process 221 may probably fail to execute.

As described above, a plurality of monitoring processes are activated, and logs including the flags for these monitoring processes are stored. This makes it easy to identify a process that is the cause of a reset. In FIGS. 9 and 10, the transmission apparatus 200 activates one intermediate priority monitoring process. However, a plurality of intermediate priority monitoring processes with different priorities may be activated. In this connection, usually, in the case where one or more monitoring processes are not executed, at least the lowest priority monitoring process 221 is not executed, whereas the highest priority monitoring process 222 is executed normally.

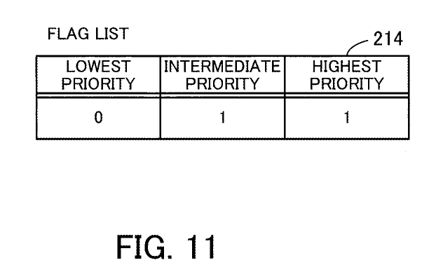

FIG. 11 illustrates an example of a flag list.

A flag list 214 is stored in the flag storage unit 213. The flag list 214 includes a lowest priority flag, an intermediate priority flag, and a highest priority flag. The lowest priority flag indicates whether the lowest priority monitoring process 221 has been executed. The intermediate priority flag indicates whether the intermediate priority monitoring process 223 has been executed. The highest priority flag indicates whether the highest priority monitoring process 222 has been executed. In addition, in the case where the transmission apparatus 200 activates a plurality of intermediate priority monitoring processes, the flag list 214 includes a plurality of corresponding intermediate priority flags.

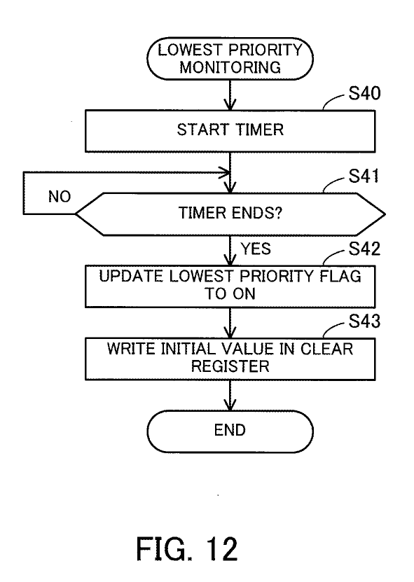

FIG. 12 is a flowchart illustrating an exemplary procedure for lowest priority monitoring according to the fourth embodiment.

The lowest priority monitoring process 221 repeatedly executes the procedure of FIG. 12.

(S40) The lowest priority monitoring process 221 starts a timer.

(S41) The lowest priority monitoring process 221 waits for the timer, which started at step S40, to end. When the timer ends, the procedure proceeds to step S42. The procedure stays at step S41 until the timer ends.

(S42) The lowest priority monitoring process 221 updates the lowest priority flag in the flag list 214 stored in the flag storage unit 213 to ON (“1”).

(S43) The lowest priority monitoring process 221 writes the initial count value in the clear register 102a of the watchdog timer 102. Then, the lowest priority monitoring process 221 proceeds back to step S40 to repeat the procedure.

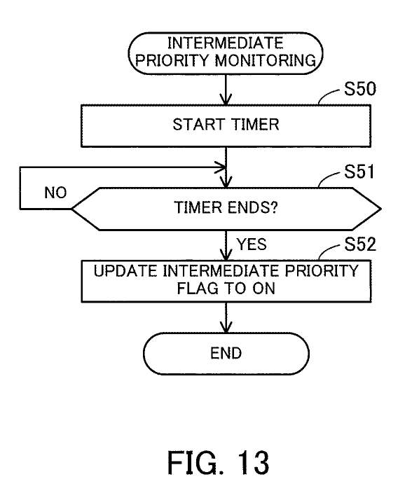

FIG. 13 is a flowchart illustrating an exemplary procedure for intermediate priority monitoring according to the fourth embodiment.

The intermediate priority monitoring process 223 repeatedly executes the procedure of FIG. 13.

(S50) The intermediate priority monitoring process 223 starts a timer. The timer used here may be a software timer provided in the OS or a hardware timer other than the watchdog timer 102 provided in the transmission apparatus 200. The timer is set equal to a time for the lowest priority monitoring process 221, and for example, set to about 10 seconds.

(S51) The intermediate priority monitoring process 223 waits for the timer, which started at step S50, to end. When the timer ends, the procedure proceeds to step S52. The procedure stays at step S51 until the timer ends. In this case, the intermediate priority monitoring process 223 may go into sleep until the timer ends. In this connection, this sleep state is ended by an interrupt from the OS or hardware timer.

(S52) The intermediate priority monitoring process 223 updates the intermediate priority flag in the flag list 214 stored in the flag storage unit 213 to ON (“1”). Then, the intermediate priority monitoring process 223 proceeds back to step S50 to repeat the procedure.

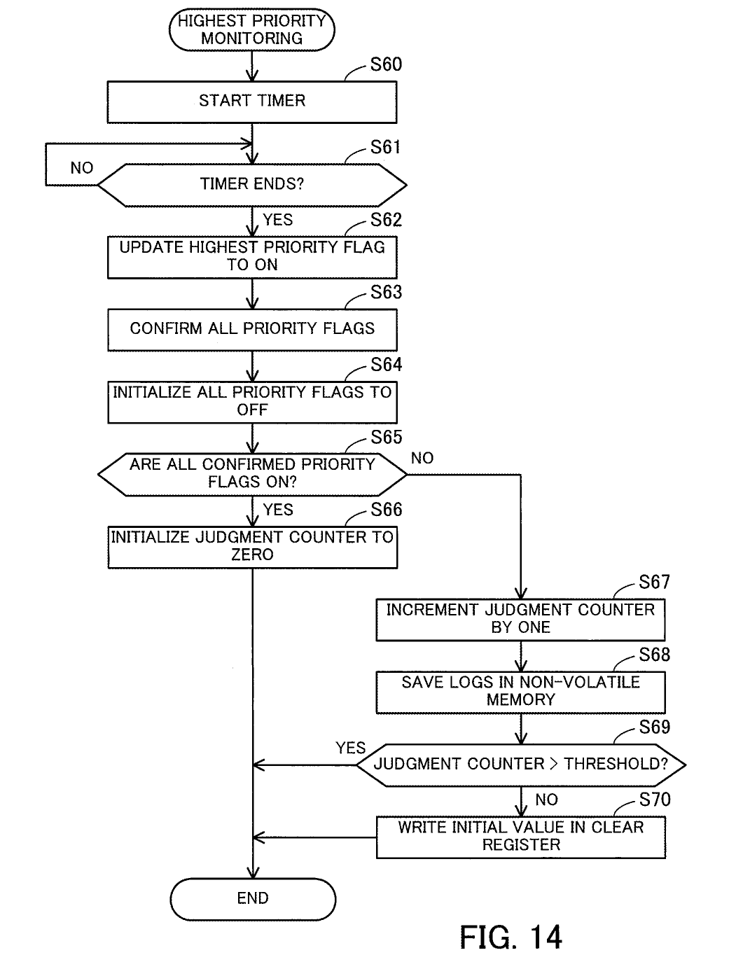

FIG. 14 is a flowchart illustrating an exemplary procedure for highest priority monitoring according to the fourth embodiment.

The highest priority monitoring process 222 repeatedly executes the procedure of FIG. 14.

(S60) The highest priority monitoring process 222 starts a timer.

(S61) The highest priority monitoring process 222 waits for the timer, which started at step S60, to end. When the timer ends, the procedure proceeds to step S62. The procedure stays at step S61 until the timer ends.

(S62) The highest priority monitoring process 222 updates the highest priority flag in the flag list 214 stored in the flag storage unit 213 to ON (“1”).

(S63) The highest priority monitoring process 222 confirms the lowest priority flag, intermediate priority flag, and highest priority flag included in the flag list 214.

(S64) The highest priority monitoring process 222 initializes the lowest priority flag, intermediate priority flag, and highest priority flag included in the flag list 214, to OFF (“0”).

(S65) The highest priority monitoring process 222 determines whether all of the flags confirmed at step S63 are ON. If all the flags are ON, the procedure proceeds to step S66. If at least one flag is OFF, the procedure proceeds to step S67.

(S66) The highest priority monitoring process 222 initializes the judgment counter stored in the judgment count storage unit 212 to zero. Then, the highest priority monitoring process 222 proceeds back to step S60 to repeat the procedure.

(S67) The highest priority monitoring process 222 increments the judgment counter by one.

(S68) The highest priority monitoring process 222 collects logs from the RAM 104. For example, the logs include OS error messages, information about inter-process communication, a history of use of the communication interface 108, environmental information including a temperature and a fan rotation count, hardware configuration information, and others. In addition, the logs include the set of flags (flags before initialization) confirmed at step S63. The highest priority monitoring process 222 saves the collected logs in the non-volatile memory 105.

(S69) The highest priority monitoring process 222 determines whether the value of the judgment counter is greater than a threshold (for example, six). If the value of the judgment counter is greater than the threshold, the highest priority monitoring process 222 presumes that the CPU 101 is in the abnormal operating state. Then, the highest priority monitoring process 222 proceeds back to step S60 to repeat the procedure. If the value of the judgment counter is less than or equal to the threshold, the highest priority monitoring process 222 presumes that the CPU 101 is in the normal high load state. Then, the procedure proceeds to step S70.

(S70) The highest priority monitoring process 222 writes the initial count value in the clear register 102a of the watchdog timer 102, in place of the lowest priority monitoring process 221. Then, the highest priority monitoring process 222 proceeds back to step S60 to repeat the procedure.

As described above, in the transmission apparatus 200 of the fourth embodiment, the highest priority monitoring process 222 monitors whether all monitoring processes are operating. If one or more monitoring processes are not operating, the highest priority monitoring process 222 saves logs from the RAM 104 to the non-volatile memory 105. While the number of times non-execution of one or more monitoring processes was detected is few, the highest priority monitoring process 222 initializes the watchdog timer 102, in place of the lowest priority monitoring process 221. If the number of times non-execution of one or more monitoring processes was detected becomes many, the highest priority monitoring process 222 stops the initialization of the watchdog timer 102.

Therefore, if the load on the CPU 101 increases temporarily, the above approach initializes the watchdog timer 102 and thereby prevents the CPU 101 from being erroneously reset. In addition, since logs are saved before the CPU 101 is reset, it becomes easy to identify the cause of a reset. In addition, a flag indicating whether the intermediate priority monitoring process 223 has operated is included in a log and stored, which makes it easy to identify a process that is the cause of a reset.

As described earlier, the information processing of the first embodiment is implemented by the information processing apparatus 10 executing a program. The information processing of the second embodiment is implemented by the information processing apparatus 20 executing a program. The information processing of the third embodiment is implemented by the information processing apparatus 100 executing a program. The information processing of the fourth embodiment is implemented by the information processing apparatus 200 executing a program.

Such a program may be recorded on a computer-readable recording medium (for example, recording medium 34). Recording media include magnetic disks, optical discs, magneto-optical discs, semiconductor memories, and others, for example. Magnetic disks include FDs and HDDs. Optical discs include CDs, CD-Rs (Recordable), CD-RWs (Rewritable), DVDs, DVD-Rs, DVD-RWs, and others. The program may be recorded on portable recording media, which are then distributed. In this case, the program is copied from a portable recording medium to another recording medium (for example, non-volatile memory 105), and then is executed.

According to one aspect, it is possible to appropriately adjust the time when a watchdog timer expires. In addition, according to another aspect, it is easy to save log information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An abnormality detection method to be executed by a computer including a processor and a timer configured to reset the processor when the timer expires, the method comprising:
activating, by the processor, a first monitoring process for initializing the timer and a second monitoring process with higher priority than the first monitoring process;
monitoring, by the processor executing the second monitoring process, whether the first monitoring process has been executed;
determining, upon determining that the first monitoring process has not been executed, by the processor executing the second monitoring process, whether a load state of the processor satisfies prescribed conditions; and
initializing the timer upon determining that the load state satisfies the prescribed conditions.

2. The abnormality detection method according to claim 1, further comprising
storing, by the processor executing the second monitoring process, a history indicating an amount of resources of the processor used by another process that is different from the first monitoring process and the second monitoring process,
wherein the determining whether the load state satisfies the prescribed conditions includes comparing a current amount of resources used by said another process with the history.

3. The abnormality detection method according to claim 1, further comprising, upon determining that the first monitoring process has not been executed, saving, by the processor executing the second monitoring process, log information from a memory provided in the computer to a non-volatile storage device.

4. The abnormality detection method according to claim 3, further comprising
activating, by the processor, a third monitoring process with priority that is higher than a priority of the first monitoring process and is lower than the priority of the second monitoring process,
wherein the log information includes information indicating whether the third monitoring process has been executed.

5. An information processing apparatus comprising:
a processor; and
a timer configured to reset the processor when the timer expires,
wherein the processor activates a first monitoring process for initializing the timer and a second monitoring process with higher priority than the first monitoring process, and
wherein the second monitoring process
monitors whether the first monitoring process has been executed,
determines, upon determining that the first monitoring process has not been executed, whether a load state of the processor satisfies prescribed conditions, and
initializes the timer upon determining that the load state satisfies the prescribed conditions.

6. A non-transitory computer-readable storage medium storing a computer program that causes a computer including a timer for resetting a processor when the timer expires to perform a procedure comprising:
activating a first monitoring process for initializing the timer and a second monitoring process with higher priority than the first monitoring process; and
executing the second monitoring process to
monitor whether the first monitoring process has been executed,
determine, upon determining that the first monitoring process has not been executed, whether a load state of the processor satisfies prescribed conditions, and
initialize the timer upon determining that the load state satisfies the prescribed conditions.
